(19) United States
(12) Patent Application Publication
(10) Pub. No.: US 2019/0210513 A1
(43) Pub. Date: Jul. 11, 2019

(54) VEHICLE AND CONTROL METHOD FOR THE SAME

(71) Applicants: Hyundai Motor Company, Seoul (KR); Kia Motors Corporation, Seoul (KR)

(72) Inventors: Bogeun Kim, Gwangmyeong (KR); Myong Gil Park, Seongnam (KR)

(21) Appl. No.: 15/986,252

(22) Filed: May 22, 2018

(30) Foreign Application Priority Data
Jan. 5, 2018 (KR) 10-2018-0001730

(51) Int. Cl. B60Q 1/14

(52) U.S. Cl. CPC B60Q 1/143; F21S 41/65

(57) ABSTRACT

A vehicle can include: a sensor collecting data of an object in front of the vehicle; a communicator receiving an object recognition algorithm from a server; a head lamp mounted to a front portion of the vehicle; a controller recognizing the object by analyzing the data of the object using the object recognition algorithm, and controlling the head lamp so as to emit light according to the recognized object; and a storage storing the data of the object and the object recognition algorithm.

### CROSS-REFERENCE TO RELATED APPLICATION

This application claims the benefit of priority under 35 U.S.C. §119 to Korean Patent Application No. 10-2018-0001730, filed on Jan. 5, 2018 in the Korean Intellectual Property Office, the disclosure of which is incorporated by reference herein in its entirety.

### BACKGROUND

### 1. Technical Field

Embodiments of the present disclosure relate generally to a vehicle and a control method for the same and, more particularly, to a vehicle capable of training an object recognition algorithm that distinguishes and recognizes an object in front of the vehicle and capable of controlling a head lamp that emits light toward the object in front of the vehicle, by using the trained object recognition algorithm, and a control method for the same.

### 2. Description of Related Art

Generally, vehicles are provided with a head lamp in a front part of the vehicle enabling a driver to easily recognize an object in front of the vehicle when driving at night. In recent years, a technology has been proposed in which the vehicle head lamp is adjusted according to the presence of a preceding vehicle or a vehicle located in front of a driving direction or according to environment information of the surroundings of the vehicle so as to enable safer driving during nighttime driving.

However, since conventional techniques for controlling the head lamps only involve controlling a head lamp depending on whether an object is present in front of the vehicle, there is a limitation in that the type of the object cannot be distinguished and the head lamp cannot adjust the light according to the distinguished object.

In an effort to address the above limitation, an algorithm or logic for controlling the head lamp has been developed and implemented in vehicles at the time of production. However, it is difficult to actively improve the algorithm or logic that is already implemented using data collected through the vehicle.

### SUMMARY

It is an aspect of the present disclosure to provide a vehicle configured to allow a driver to clearly distinguish an object in front of the vehicle by distinguishing and recognizing the object an object recognition algorithm, and by controlling light emitted to the object by a vehicle head lamp, and a control method for the same.

It is another aspect of the present disclosure to provide a vehicle configured to improve the accuracy of recognition of an object in front of the vehicle and to reduce the system development cost by transmitting data of the object to a server in real-time, and by training the object recognition algorithm using the data as training data, and a control method for the same.

It is another aspect of the present disclosure to provide a vehicle configured to prevent traffic accidents by informing a following vehicle of a dangerous situation when it is detected that danger is present in the front of the vehicle using the trained object recognition algorithm and a control method for the same.

Additional aspects of the present disclosure will be set forth in part in the description which follows and, in part, will be apparent from the description, or may be learned by practice of the present disclosure.

According to embodiments of the present disclosure, a vehicle may comprise: a sensor collecting data of an object in front of the vehicle; a communicator receiving an object recognition algorithm from a server; a head lamp mounted to a front portion of the vehicle; a controller recognizing the object by analyzing the data of the object using the object recognition algorithm, and controlling the head lamp so as to emit light according to the recognized object; and a storage storing the data of the object and the object recognition algorithm.

The vehicle may further comprise a navigator updating and displaying information related to an area in which a certain object appears and information related to a high accident area based on a result of the analyzing of the data of the object.

The controller may control the communicator so as to transmit the data of the object for training the object recognition algorithm in real-time.

The controller may control the head lamp so as to adjust an intensity and a direction of the light emitted from the head lamp according to the recognized object.

The controller may enable the object recognition algorithm to be regularly or irregularly updated in real-time based on a result of the analyzing of the data of the object.

The controller may control the communicator so as to transmit a danger warning signal to a following vehicle according to a result of the analyzing of the data of the object.

Furthermore, according to embodiments of the present disclosure, a control method of a vehicle may comprise: collecting, by a sensor coupled to the vehicle, data of an object in front of the vehicle; receiving, by a communicator coupled to the vehicle, an object recognition algorithm from a server; transmitting, by the communicator, the data of the object to the server; recognizing, by a controller coupled to the vehicle, the object by analyzing the data of the object using the object recognition algorithm; and controlling, by the controller, a head lamp mounted to a front portion of the vehicle so as to emit light according to the recognized object.

The control method may further comprise updating, by a navigator coupled to the vehicle, information related to an area in which a certain object appears and information related to a high accident area based on a result of the analyzing of the data of the object.

The control method may further comprise controlling, by the controller, the communicator so as to transmit the data of the object for training the object recognition algorithm in real-time.

The control of the head lamp may be performed by controlling the head lamp so as to adjust an intensity and a direction of the light emitted from the head lamp according to the recognized object.

The control method may further comprise enabling, by the controller, the object recognition algorithm to be regularly or irregularly updated in real-time based on a result of the analyzing of the data of the object.

The control method may further comprise controlling, by a controller, the communicator so as to transmit a danger warning signal to a following vehicle according to a result of the analyzing of the data of the object.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 shows the exterior of a vehicle, according to embodiments of the present disclosure;

FIG. 2 shows internal features of vehicle, according to embodiments of the present disclosure;

FIG. 3 is a control block diagram of a vehicle, according to embodiments of the present disclosure;

FIG. 4 shows a relationship between a vehicle, a server, and a following vehicle;

FIG. 5 is a flowchart illustrating a control method of a vehicle, according to embodiments of the present disclosure; and

FIG. 6 is an additional flowchart illustrating a control method of a vehicle, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure.

In the following description, like reference numerals refer to like elements throughout the specification. Well-known functions or constructions are not described in detail since they would obscure the one or more exemplar embodiments with unnecessary detail. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”. Also, when a part “includes” or “comprises” an element, unless there is a particular description contrary thereto, the part may further include other elements, not excluding the other elements.

It will be understood that, although the terms first, second, third, etc., may be used herein to describe various elements, but is should not be limited by these terms.

These terms are only used to distinguish one element from another element. As used herein, the singular forms “a,” “an” and “the” are intended to include the plural forms as well, unless the context clearly indicates otherwise. With respect to flowcharts described herein, each step may be implemented in the order different from the illustrated order unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, or the like, as described herein. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Reference will now be made in detail to embodiments of the present disclosure, examples of which are illustrated in the accompanying drawings.

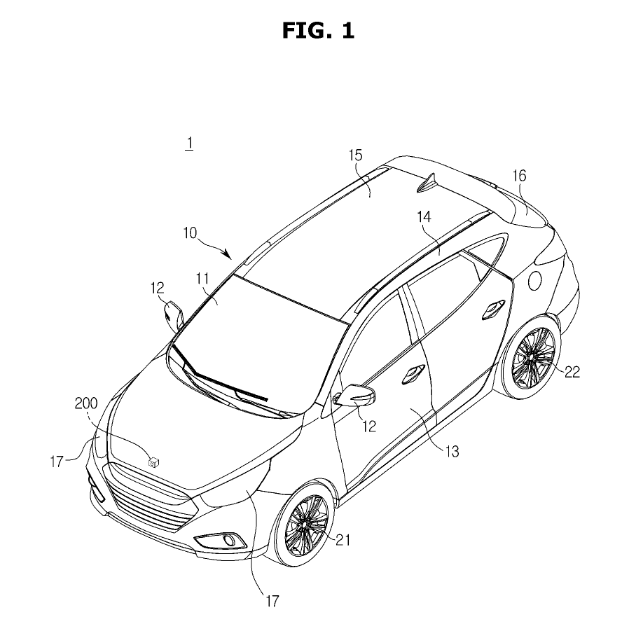

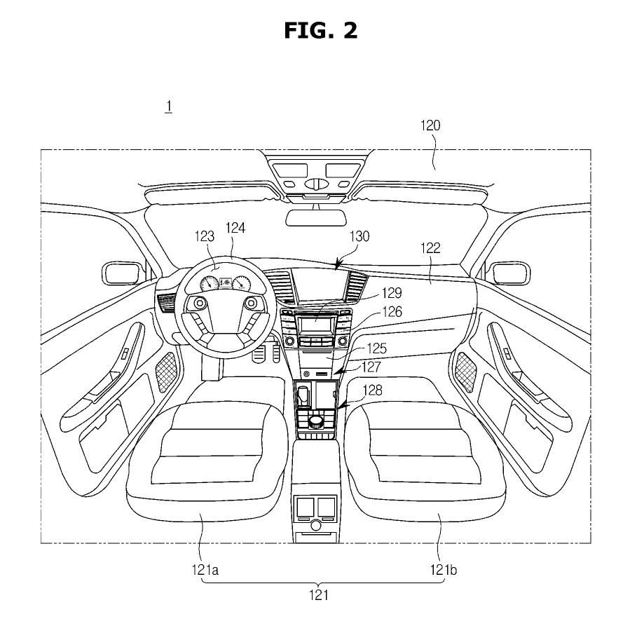

FIG. 1 is a view illustrating an appearance of a vehicle according to embodiments of the present disclosure, and FIG. 2 is a view illustrating an interior of the vehicle according to embodiments of the present disclosure.

Referring first to FIG. 1, an exterior of a vehicle 1 may include a body 10 forming an exterior of the vehicle 1, a windscreen 11 providing a front view of the vehicle 1 to a driver, a side mirror 12 providing a view of a rear side of the vehicle 1 to the driver, a door 13 closing the inside of the vehicle 1 from the outside, a pillar 14 supporting a roof panel, the roof panel 15, a rear window glass 16, a head lamp 17, a front wheel 21 disposed on a front side of the vehicle 1 and a rear wheel 22 disposed on a rear side of the vehicle 1, wherein the front wheel 21 and the rear wheel 22 may be referred to as a vehicle wheel.

The windscreen 11 may be provided on an upper portion of the front of the body 10 to allow a driver inside the vehicle 1 to acquire visual information about the front of the vehicle 1. The side mirror 12 may include a left side mirror provided on the left side of the body 10 and a right side mirror provided on the right side of the body 10, and may allow a driver inside the vehicle 1 to acquire visual information of the lateral side and the rear side of the vehicle 1.

The door 13 may be rotatably provided on a right side and a left side of the body 10. When the door 13 is opened, a driver may be allowed to be seated in the vehicle 1, and when the door 13 is closed, the inside of the vehicle 1 may be closed from the outside.

The vehicle 1 may include a sensor 200 sensing an object located in front, side and rear of the vehicle. The sensor 200 may be mounted to the inside of a front radiator grill or the inside of the front head lamp of the vehicle 1. Alternatively, the sensor 200 may be integrally implemented with a hot wire in the rear side of the roof panel 15 that is the upper side of the rear window glass 16. However, there is no limitation in the position of the sensor 200.

The sensor 200 may be configured to measure a distance to an object located at a regular interval, wherein the sensor 200 may include a laser sensor, an infrared sensor, a radar sensor, or a LiDAR sensor. The sensor 200 may scan surface information of an object in a measurement range while the vehicle moves. The sensor 200 may be an image sensor configured to capture an image of the vicinity of the vehicle.

The LiDAR sensor is configured to radiate a laser to a target and detect the laser reflated by the target so as to detect a distance to a target, a direction, a speed, temperature, material distribution and concentration characteristics of the target. The LiDAR sensor may scan a surface of a target by sampling method and output the sample point data.

The image sensor may acquire an image of the outside of the vehicle. Particularly, the image sensor may acquire an image of a front road on which the vehicle is driving. The image sensor may be implemented by a camera.

It is understood that the exterior of the vehicle 1 as described above and illustrated in FIG. 1 is provided merely for demonstration purposes, and therefore does not limit the scope of the present disclosure.

Referring next to FIG. 2, an interior 120 of the body may include a seat 121; 121a and 121b on which a passenger is seated, a dashboard 122, an instrument panel 123, i.e. a cluster, a steering wheel 124 to change the direction of the vehicle, and a center fascia 125 in which an operation panel of an audio device and an air conditioning device is installed, wherein the instrument panel 123 may be disposed on the dashboard 122 and may include tachometer, speedometer, coolant temperature indicator, fuel indicator, turn signal indicator, high beam indicator light, warning light, seat belt warning light, trip odometer, odometer, automatic transmission selector lever indicator, door open warning light, oil warning light, and a low fuel warning light.

The seat 121 may include a driver seat 121a on which a driver is seated, a passenger seat 121b on which a passenger is seated, and a rear seat provided in the rear side of the inside of the vehicle.

The cluster 123 may be implemented in a digital manner. The cluster 123 in the digital manner may display vehicle information and driving information as an image.

The center fascia 125 may be disposed between the driver seat 121a and the passenger seat 121b on the dashboard 122, and may include a head unit 126 configured to control the audio device, the air conditioning device and a hot-wire in the seat. The head unit 126 may include a plurality of buttons to receive an input of an operation command for the audio device, the air conditioning device, and the hot-wire in the seat.

In the center fascia 125, an air outlet, a cigar jack, and a multi-terminal 127 may be installed. The multi-terminal 127 may be disposed adjacent to the head unit 126, and may include a USB port, an AUX terminal, and further include a SD slot.

The vehicle 1 may further include an input 128 configured to receive an operation command of a variety of functions, and a display 129 configured to display information related to a function currently performed, and information input by a user.

A display panel of the display 129 may employ Light Emitting Diode (LED) panel, Organic Light Emitting Diode (OLED) panel or Liquid Crystal Display (LCD) panel.

The input 128 may be disposed on the head unit 126 and the center fascia 125, and may include at least one physical button such as On/Off button for operation of the variety of functions, and a button to change a set value of the variety of functions. The input 128 may transmit an operation signal of the button to an Electronic Control Unit (ECU), a controller 400, the AVN device 130, or a navigator 700, wherein the AVN device 130 and the navigator 700 may be integrally formed with each other.

The input 128 may include a touch panel integrally formed with the display of the AVN device 130. The input 128 may be activated and displayed in the shape of the button, on the display of the AVN device 130, and may receive an input of the location information of the button displayed.

The input 128 may further include a jog dial (not shown) or a touch pad to input a command for moving cursor and selecting cursor, wherein the cursor is displayed on the display of the AVN device 130. The jog dial or touch pad may be provided in the center fascia.

Particularly, the input 128 may receive any one of input of a manual driving mode, in which a driver directly drives a vehicle, and an autonomous driving mode, and may transmit an input signal of the autonomous driving mode to the controller 400 when the autonomous driving mode is input.

The controller 400 may transmit a signal, which is related to a control command about devices in the vehicle 1, to each device while the controller 400 may distribute a signal to devices in the vehicle 1. Although it is referred to as the controller 400, this is an expression for being interpreted in a broad sense, but is not limited thereto.

When a navigation function is selected, the input 128 may receive an input of information related to the destination, and transmit the input information related to the destination to the AVN device 130, and when a DMB function is selected, the input 128 may receive an input of information related to the channel and sound volume, and transmit the input information related to the channel and sound volume to the AVN device 130.

The AVN device 130 configured to receive information from a user and to output a result corresponding to the input information may be provided in the center fascia 125.

The AVN device 130 may perform at least one function of a navigation function, a DMB function, an audio function, and a video function, and may display information related to the road condition and the driving during the autonomous driving mode. The AVN device 130 may be installed on the dash board to be vertically stood.

The chassis of the vehicle may further include a power system, a power train, a steering system, a brake system, a suspension system, a transmission device, a fuel system and front, rear, left and right vehicle wheels. The vehicle may further include a variety of safety devices for a driver and passenger safe.

The safety devices of the vehicle may include a variety of safety devices, such as an air bag control device for the safety of the driver and passenger when the collision of the vehicle, and an Electronic Stability Control (ESC) configured to maintain the stability of the vehicle when accelerating or cornering.

The vehicle 1 may further include a detection device, e.g. a proximity sensor configured to detect an obstacle or another vehicle placed in the rear side or the lateral side of the vehicle; a rain sensor configured to detect whether to rain or an amount of rain; a wheel speed sensor configured to detect the wheel of the vehicle; a lateral acceleration sensor configured to detect a lateral acceleration of the vehicle; a yaw rate senor and a gyro sensor configured to detect the variation of angular speed of the vehicle; and a steering angle sensor configured to detect a rotation of a steering wheel of the vehicle.

The vehicle 1 may include an Electronic Control Unit (ECU) configured to control an operation of the power system, the power train, the driving device, the steering system, the brake system, the suspension system, the transmission device, the fuel system, the variety of safety devices, and the variety of sensors.

The vehicle 1 may selectively include an electronic device such as a hand-free device, a GPS, an audio device, a Bluetooth device, a rear camera, a device for charging terminal device, and a high-pass device, which are installed for the convenience of the driver.

The vehicle 1 may further include an ignition button configured to input an operation command to an ignition motor (not shown). That is, when the ignition button is turned on, the vehicle 1 may turn on an ignition motor (not shown) and drive an engine (not shown) that is the power generation device, by the operation of the ignition motor.

The vehicle 1 may further include a battery (not shown) configured to supply a driving power by being electrically connected to a terminal device, an audio device, an interior lamp, an ignition motor and other electronic device. The battery may perform a charging by using a generator itself or power from an engine, while the vehicle drives.

It is understood that the interior of the vehicle 1 as described above and illustrated in FIG. 2 is provided merely for demonstration purposes, and therefore does not limit the scope of the present disclosure.

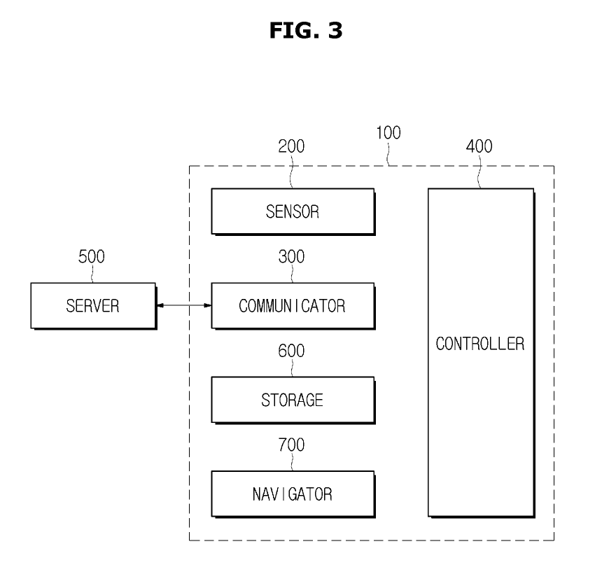

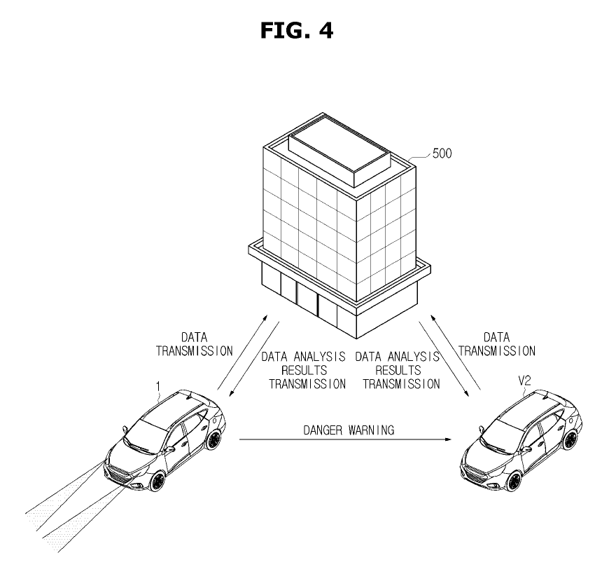

FIG. 3 is a control block diagram illustrating the vehicle according to embodiments of the present disclosure, and FIG. 4 is a view illustrating a relationship among the vehicle, a server and a following vehicle according to embodiments of the present disclosure.

Referring first to FIG. 3, the vehicle may include a sensor 200, a communicator 300, a controller 400, a storage 600 and a navigator 700.

The sensor 200 may include a variety of devices configured to detect or recognize an object, wherein the sensor 200 may include a front/rear sensor, a front/rear camera, a front lateral side sensor and a rear lateral side sensor.

When the sensor 200 is a Lidar sensor, the sensor 200 may radiate a laser pulse signal and measure a period of time in which a pulse signal reflected by objects in a measurement range arrives, so as to measure a distance to the objects. In addition, the sensor 200 may measure spatial coordinates of the object, and collect three-dimensional information of the object. The sensor 200 may scan a surface of a target by sampling method and output the sample point data.

When sensor 200 is an image sensor, the sensor 200 may collect image data around the vehicle 1. The sensor 200 may acquire the images of objects around the vehicle 1 by capturing the vicinity of the vehicle 1. The sensor 200 may acquire an image of other vehicle located in the front, rear and lateral side of the vehicle 1, and detect a lane by acquiring an image of the road on which the vehicle 1 moves.

The communicator 300 may transmit and receive data to and from the server 500 or a following vehicle. The communicator 300 may include at least one of a wireless communication module and a wired communication module. The wireless communication module may include at least one of a wireless LAN communication module (Wireless Local Area Network (WLAN) or Wireless Fidelity (Wi-Fi) or Worldwide Interoperability for Microwave Access (WiMAX)) or wireless PAN communication module (wireless personal area network (WPAN)).

The controller 400 may analyze the data of an object in front of the vehicle 1, which is collected by the sensor 200, by using the object recognition algorithm. The controller 400 may distinguish and recognize an object in front of the vehicle by analyzing the data of the object in front of the vehicle. For example, an object in front of the vehicle may include people, animals, a preceding vehicle, a sign and an obstacle, and the controller 400 may distinguish and recognize the object.

The controller 400 may adjust light emitted to the front object, which is distinguished and recognized. In other words, the controller 400 may adjust the intensity and direction of the light emitted to the front object by controlling the head lamp 17. The light emitted by the head lamp 17 may vary based on the distinguished and recognized object in front of the vehicle.

For example, when an object in front of the vehicle is recognized as people, animals or obstacles on the road, the controller 400 may allow light from the head lamp 17 to be strongly emitted to a position in which the corresponding object is located so that a driver clearly identifies the corresponding object. When an object in front of the vehicle is recognized as a vehicle, the controller 400 may allow the intensity of the light to be weak or the controller 400 may allow the head lamp 170 to be turned off. Accordingly, it may be possible to prevent the interruption of the driving of the preceding vehicle caused by the light. In addition, when an object in front of the vehicle is a road sign, the controller 400 may control the head lamp 17 so that the intensity and direction of the light of the head lamp 17 is controlled to allow a driver to clearly identify the corresponding road sign.

Meanwhile, the controller 400 may set an area to which the light of the head lamp 17 is emitted, and make a grid in the area by a plurality of spots. The controller 400 may allow the light of the head lamp 17 to be adjusted, wherein the light is emitted to a position in which an object in front of the vehicle is located, in the region divided as grids by the plurality of spots.

The object recognition algorithm, which is used by the controller 400 to distinguish and recognize an object in front of the vehicle, may be stored in the storage 600 in the vehicle 1. The vehicle 1 may receive the object recognition algorithm from the server 500. The storage 600 may store data of an object in front of the vehicle which is collected by the sensor 200.

The object recognition algorithm may distinguish and recognize an object in front of the vehicle by matching shape data predefined for each object, with key-points and feature vectors (descriptors) extracted from the data of the object collected by the sensor 200. The geometric transformation relation between matched data pairs may be estimated using Random Sample Consensus (RANSAC). When a valid conversion relation is detected, it is determined that the object is recognized, and when a valid conversion relation is not detected, it is determined that the object is not recognized.

The controller 400 may use various object recognition algorithms. The object recognition algorithms may include Scale Invariant Feature Transform (SIFT), Speed Up Robust Features (SURF), Oriented FAST and Rotated BRIEF (ORB), and Ferns Algorithm. The object recognition algorithm may be trained by training data.

Training of the object recognition algorithm may be performed in the server 500. The object recognition algorithm may be trained by a machine learning method. The controller 400 may allow the data of the object in front of the vehicle collected by the sensor 200 to be transmitted to the server 500 (e.g., via the communicator 300), and thus the data of the object in front of the vehicle may become training data for training of the object recognition algorithm.

Referring next to FIG. 4, the controller 400 may allow the data of the object in front of the vehicle to be transmitted in real-time, and the controller 400 may allow trained object recognition algorithm to be regularly or irregularly received from the server 500 in real-time. The controller 400 may more accurately distinguish and recognize the object in front of the vehicle by using the object recognition algorithm that is continuously trained, and thus the controller 400 may more precisely control the light emitted to the object.

The vehicle 1 may transmit the data of the object in front of the vehicle to the server 500 in real-time, and train the object recognition algorithm by using the data as training data. Therefore, it may be possible to improve the accuracy of recognition of the object in front of the vehicle and to reduce the system development cost.

The controller 400 of the vehicle 1 may receive the result of analyzing the data of the object in front of the vehicle from the server 500, and the controller 400 may allow the navigator 700 to update information related to an area in which a certain object appears and information related to a high accident area. The “high accident area” may include an area in which a number of accidents in such area exceeds a predetermined threshold amount. The navigator 700 may display the updated information related to the area in which a certain object appears and the updated information related to the high accident area. The server 500 may analyze the data of the object in front of the vehicle collected by the sensor 200 of the vehicle 1 to extract an area in which a certain object frequently appears or the high accident area. For example, the server 500 may extract an area with a high population, an area in which animals appear and an area in which an obstacle is present, by analyzing the data. In addition, the server 500 may collect data from a plurality of vehicles and extract an area in which a certain object frequently appears or the high accident area based on the accumulated data.

The controller 400 may control the navigator 700 so as to continuously update the information related to an area in which a certain object appears and the information related to a high accident area. As a result, a driver may avoid accidents in such area utilizing the information.

The vehicle 1 may transmit a danger warning signal to a following vehicle V2 according to the result of analyzing data of the object in front of the vehicle, which is performed by the controller 400. The controller 400 may recognize a certain object present in front of the vehicle by using the object recognition algorithm, and when a danger is expected to occur due to the recognized object in front of the vehicle, the controller 400 may transmit a danger warning signal to the following vehicle V2. The controller 400 may transmit a head lamp control signal configured to adjust the light of the head lamp of the following vehicle V2.

In other words, when it is analyzed that the danger is present in front of the vehicle by using the trained object recognition algorithm, the vehicle 1 may inform the following vehicle V2 of the danger and at the same time, the vehicle 1 may allow the light of the head lamp to be appropriately adjusted to secure a forward visibility. Therefore, it may be possible to prevent traffic accidents.

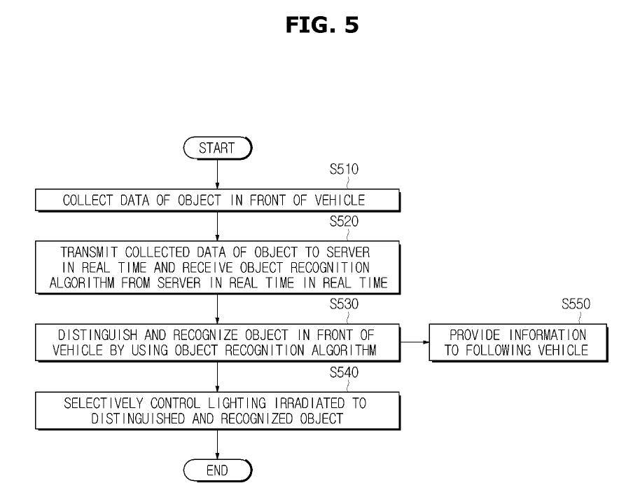

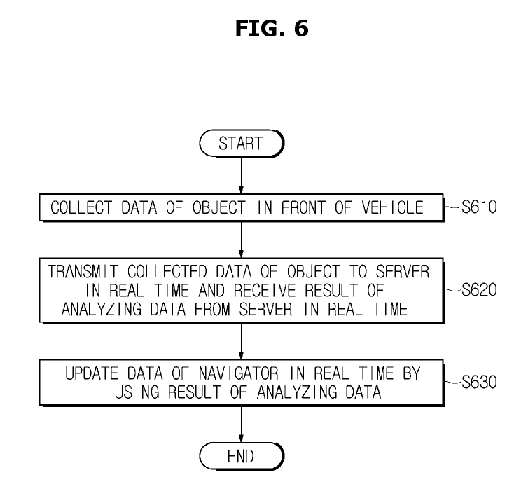

FIG. 5 is a flowchart illustrating a vehicle control method according to embodiments of the present disclosure, and FIG. 6 is an additional flowchart illustrating a vehicle control method according to embodiments of the present disclosure.

Referring first to FIG. 5, the vehicle 1 may collect data of an object in front of the vehicle by using the sensor 200 (510). The vehicle 1 may transmit the collected data of the object in front of the vehicle to the server 500, and receive trained object recognition algorithm from the server 500 (520). The vehicle 1 may transmit the data of the object in front of the vehicle in real-time, and regularly or irregularly receive the trained object recognition algorithm, in real-time.

The controller 400 of the vehicle 1 may distinguish and recognize the object in front of the vehicle by using the object recognition algorithm (530). The controller 400 may distinguish and recognize an object in front of the vehicle by analyzing the data of the object in front of the vehicle. For example, an object in front of the vehicle may include people, animals, a preceding vehicle, a sign and an obstacle, and the controller 400 may distinguish and recognize the object.

The controller 400 may selectively control light emitted to the recognized object in front of the vehicle (540). In other words, the controller 400 may control the head lamp 17 so that the light, which is emitted to the recognized object in front of the vehicle, is adjusted. The controller 400 may adjust the intensity and direction of the light emitted to the front object by controlling the head lamp 17. The light emitted by the head lamp 17 may vary based on the distinguished and recognized object in front of the vehicle.

The vehicle 1 may transmit a danger warning signal to a following vehicle V2 according to the result of analyzing data of the object in front of the vehicle, which is performed by the controller 400 (550). The controller 400 may recognize a certain object present in front of the vehicle by using the object recognition algorithm, and when a danger is expected to occur due to the recognized object in front of the vehicle, the controller 400 may transmit a danger warning signal to the following vehicle V2. The controller 400 may transmit a head lamp control signal configured to adjust the light of the head lamp of the following vehicle V2.

Referring next to FIG. 6, the vehicle 1 may collect data of an object in front of the vehicle by using the sensor 200 (610). The vehicle 1 may transmit the collected data of the object in front of the vehicle to the server 500, and receive the result of analyzing the data of the object in front of the vehicle, which is performed by the server 500 (620). The result of analyzing the data of the object in front of the vehicle, which is performed by the server 500, may include information related to an area in which a certain object appears and information related to a high accident area. The vehicle 1 may update the data of the navigator 700 by receiving the information related to an area in which a certain object appears and the information related to a high accident area from the server 500 (630).

As is apparent from the above description, the vehicle 1 and the control method for the same may distinguish and recognize an object in front of the vehicle using an object recognition algorithm, and light emitted from a vehicle had lamp can be controlled according to the distinguished and recognized object to allow a driver to clearly distinguish the object in front of the vehicle.

The vehicle 1 and the control method for the same may also transmit data of an object in front of the vehicle to a server in real-time, and train the object recognition algorithm using the data as training data, so as to improve the accuracy of recognition of object in front of the vehicle and to reduce the system development cost.

The vehicle 1 and the control method for the same may also prevent traffic accidents by informing a following vehicle of a dangerous situation when it is detected that a danger is present in front of the vehicle using the trained object recognition algorithm.

The disclosed embodiments may be implemented as a recording medium storing a command executable by a computer. The command may be stored in the program code type. When executed by the processor, a program module may be generated and perform the disclosed embodiments. The recording medium may be implemented as a computer readable recording medium.

The disclosed embodiments may be implemented as a computer code on a computer readable recording medium. The computer readable recording medium may include various kinds of recording medium stored data decrypted by the computer system. For example, there may be a Read Only Memory (ROM), a Random Access Memory (RAM), a magnetic tape, a magnetic disk, a flash memory, and an optical data storage device

Although a few embodiments of the present disclosure have been shown and described, it would be appreciated by those skilled in the art that changes may be made in these embodiments without departing from the principles and spirit of the disclosure, the scope of which is defined in the claims and their equivalents.

### DESCRIPTION OF SYMBOLS

1: vehicle
200: sensor
300: communicator
400: controller
500: server
600: storage
700: navigator

What is claimed is:

1. A vehicle comprising:
a sensor collecting data of an object in front of the vehicle;
a communicator receiving an object recognition algorithm from a server;
a head lamp mounted to a front portion of the vehicle;
a controller recognizing the object by analyzing the data of the object using the object recognition algorithm, and controlling the head lamp so as to emit light according to the recognized object; and
a storage storing the data of the object and the object recognition algorithm.

2. The vehicle of claim 1, further comprising:
a navigator updating and displaying information related to an area in which a certain object appears and information related to a high accident area based on a result of the analyzing of the data of the object.

3. The vehicle of claim 1, wherein
the controller controls the communicator so as to transmit the data of the object for training the object recognition algorithm in real-time.

4. The vehicle of claim 1, wherein
the controller controls the head lamp so as to adjust an intensity and a direction of the light emitted from the head lamp according to the recognized object.

5. The vehicle of claim 1, wherein
the controller enables the object recognition algorithm to be regularly or irregularly updated in real-time based on a result of the analyzing of the data of the object.

6. The vehicle of claim 1, wherein
the controller controls the communicator so as to transmit a danger warning signal to a following vehicle according to a result of the analyzing of the data of the object.

7. A control method of a vehicle comprising:
collecting, by a sensor coupled to the vehicle, data of an object in front of the vehicle;
receiving, by a communicator coupled to the vehicle, an object recognition algorithm from a server;
transmitting, by the communicator, the data of the object to the server;
recognizing, by a controller coupled to the vehicle, the object by analyzing the data of the object using the object recognition algorithm; and
controlling, by the controller, a head lamp mounted to a front portion of the vehicle so as to emit light according to the recognized object.

8. The control method of claim 7, further comprising:
updating, by a navigator coupled to the vehicle, information related to an area in which a certain object appears and information related to a high accident area based on a result of the analyzing of the data of the object.

9. The control method of claim 7, further comprising:
controlling, by the controller, the communicator so as to transmit the data of the object for training the object recognition algorithm in real-time.

10. The control method of claim 7, further comprising:
controlling, by the controller, the head lamp so as to adjust an intensity and a direction of the light emitted from the head lamp according to the recognized object.

11. The control method of claim 7, wherein
enabling, by the controller, the object recognition algorithm to be regularly or irregularly updated in real-time based on a result of the analyzing of the data of the object.

12. The control method of claim 7, further comprising:
controlling, by a controller, the communicator so as to transmit a danger warning signal to a following vehicle according to a result of the analyzing of the data of the object.
